(19) United States
(12) Patent Application Publication
(10) Pub. No.: US 2014/0318944 A1
(43) Pub. Date: Oct. 30, 2014

(54) CATALYTIC PYROLYSIS OF BIOMASS USING A MULTI-STAGE CATALYST REGENERATOR

(71) Applicant: UOP LLC, Des Plaines, IL (US)

(72) Inventors: Lance A. Baird, Prospect Heights, IL (US); Tom N. Kalnes, LaGrange, IL (US); Douglas B. Galloway, Mount Prospect, IL (US)

(73) Assignee: UOP LLC, Des Plaines, IL (US)

(21) Appl. No.: 13/870,884

(22) Filed: Apr. 25, 2013

(51) Int. Cl. B01J 38/20; C10B 57/00

(52) U.S. Cl. CPC B01J 38/20; C10B 57/00
USPC 201/2.5; 202/105; 202/117

(57) ABSTRACT

Disclosed in one embodiment is a method for the catalytic pyrolysis of a carbonaceous material that includes contacting the carbonaceous material with a plurality of catalyst particles to produce a gas phase product and a solid phase product and separating the gas phase product from the solid phase product and the plurality of catalyst particles. The method further includes partially regenerating the plurality of catalyst particles by exposing the solid phase product and the catalyst particles to a first oxidizing condition to produce an oxidized solid phase and a partially-regenerated catalyst and cooling the partially-regenerated catalyst and a non-oxidized portion of the solid phase product. Still further, the method includes further regenerating the partially-regenerated catalyst by exposing the non-oxidized portion of the solid phase product and the partially-regenerated catalyst to a second oxidizing condition.

### STATEMENT REGARDING FEDERALLY SPONSORED RESEARCH OR DEVELOPMENT

This invention was made with Government support under ZFT-0-40619-01, awarded by the United States Department of Energy. The Government has certain rights in the invention.

### TECHNICAL FIELD

The present disclosure generally relates to systems and methods for the catalytic pyrolysis of carbonaceous materials. More particularly, the present disclosure relates to systems and methods that employ a multi-stage regenerator to regenerate a catalyst employed in the catalytic pyrolysis of carbonaceous materials such as biomass.

### BACKGROUND

The processing of carbonaceous feedstocks to produce heat, chemicals, or fuels can be accomplished by a number of thermochemical processes. Conventional thermochemical processes, such as combustion, gasification, and liquefaction are typically equilibrium processes and yield relatively low-value equilibrium products including quantities of non-reactive solids (char, coke, etc.), secondary liquids (heavy tars, aqueous solutions, etc.), and non-condensible gases (CO₂, CO, CH₄, etc.). Each such process has certain inherent deficiencies. Combustion is restricted to immediate thermal applications. Gasification normally produces low energy fuel gas with limited uses. Liquefaction often produces low yields of valuable liquid or gaseous products. In addition, the liquid products that are produced by liquefaction often require considerable secondary upgrading (i.e., refining).

Pyrolysis, and in particular catalytic pyrolysis, is an alternative thermochemical process that does not suffer from the above-noted drawbacks of combustion, gasification, and liquefaction. Pyrolysis is a generic term that encompasses various methods of rapidly imparting a relatively high temperature to feedstocks for a very short time, then rapidly reducing the temperature of the primary products before chemical equilibrium can occur. Pyrolysis is characterized by the thermal decomposition of materials in the relative absence of oxygen (i.e., significantly less oxygen than required for complete combustion). By this approach, the complex structures of carbonaceous feedstocks, such as biomass, are broken into reactive chemical fragments that are initially formed by depolymerization and volatilization reactions, but do not persist for any significant length of time. Thus, non-equilibrium products are preserved, and valuable reactive chemicals, chemical intermediates, light primary organic liquids, specialty chemicals, petrochemicals, and/or high quality fuel gases can be selected and maximized at the expense of the low-value solids (char, coke, etc.) and heavy secondary organic liquids (tars, creosotes, etc.).

The conversion of biomass feedstock into bio-oil, i.e., a renewable liquid fuel derived from biological sources, has become a valuable process for producing an alternative fuel source. Biomass feedstock includes, but is not limited to lignocellulosic materials including cellulose, hemicellulose and lignin or portions thereof, such as short rotation forestry products, sawmill residues, forest residues, wood chips, chaff, grains, grasses, agricultural residues such as corn stover and sugar cane bagasse, weeds, aquatic plants such as whole algae and lipid extracted algae, hay, recycled and non-recycled paper and paper products, and any other biogenically-derived material. Typically, the biomass feedstock is ground into particles and delivered to a conversion reactor. In the conversion reactor, the biomass feedstock can be converted to bio-oil through catalytic or thermal processes. For both catalytic and thermal conversion processes, the biomass particles may be transported through the conversion reactor by a carrier gas. Further, the biomass particles may be contacted with solid catalyst particles or with solid heat transfer medium particles. The carrier gas, biomass particles, solid catalyst particles and/or solid heat transfer medium particles form a fluidized solid stream.

In addition to the primary liquid hydrocarbon product, the catalytic pyrolysis of biomass produces a byproduct coke (carbon-containing solids) on the catalyst and high carbon-content “biochar” (charcoal formed as a byproduct of pyrolysis of biomass). These byproducts are typically burned to reheat and regenerate the catalyst in a regeneration phase of the pyrolysis process. However, for many operating conditions used in the pyrolysis of many biomass feedstocks, the combustion of the coke and biochar provides more energy than required for regeneration, thus heating the catalyst to a temperature far higher than required by the biomass pyrolysis reaction, and in some cases to a temperature that may thermally damage the catalyst.

Accordingly, it would be desirable to provide an improved biomass pyrolysis reactor system that includes a regenerator that is able to combust the coke on the catalyst and the biochar without overheating the catalyst. It would further be desirable to provide an improved biomass pyrolysis process employing such a system. Still further, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Systems and methods for the catalytic pyrolysis of biomass are disclosed herein. In an exemplary embodiment, a method for the catalytic pyrolysis of a carbonaceous material that includes contacting the carbonaceous material with a plurality of catalyst particles to produce a gas phase product and a solid phase product and separating the gas phase product from the solid phase product and the plurality of catalyst particles. The method further includes partially regenerating the plurality of catalyst particles by exposing the solid phase product and the catalyst particles to a first oxidizing condition to produce an oxidized solid phase and a partially-regenerated catalyst and cooling the partially-regenerated catalyst and a non-oxidized portion of the solid phase product. Still further, the method includes further regenerating the partially-regenerated catalyst by exposing the non-oxidized portion of the solid phase product and the partially-regenerated catalyst to a second oxidizing condition.

In another exemplary embodiment, a system for the catalytic pyrolysis of a carbonaceous material that includes a pyrolysis reactor configured to contact the carbonaceous material with a pyrolysis catalyst to produce a gas phase product and a solid phase product and separation system configured to separate the gas phase product from the solid phase product. The system further includes a first regeneration system configured to oxidize the solid phase product and produce an oxidized solid phase and a partially-regenerated catalyst and a cooling system configured to cool the partially-regenerated catalyst and any non-oxidized solid phase. Still further, the system includes a second regeneration system configured to oxidize the non-oxidized solid phase and produce a regenerated catalyst.

### BRIEF DESCRIPTION OF THE DRAWINGS

The systems and methods of the present disclosure will hereinafter be described in conjunction with the following drawing Figures, wherein like numerals denote like elements, and wherein:

FIG. 1 is a diagram of a system known in the art for the catalytic pyrolysis of biomass; and

FIGS. 2-4 illustrate a system in accordance with one embodiment of the present disclosure for the catalytic pyrolysis of biomass.

### DETAILED DESCRIPTION

The following detailed description is merely exemplary in nature and is not intended to limit the disclosure or the application and uses of the illustrated embodiments. All of the embodiments and implementations described herein are exemplary embodiments provided to enable persons skilled in the art to make or use the invention and not to limit the scope of the invention, which is defined by the claims. Furthermore, there is no intention to be bound by any expressed or implied theory presented in the preceding technical field, background, brief summary, or the following detailed description.

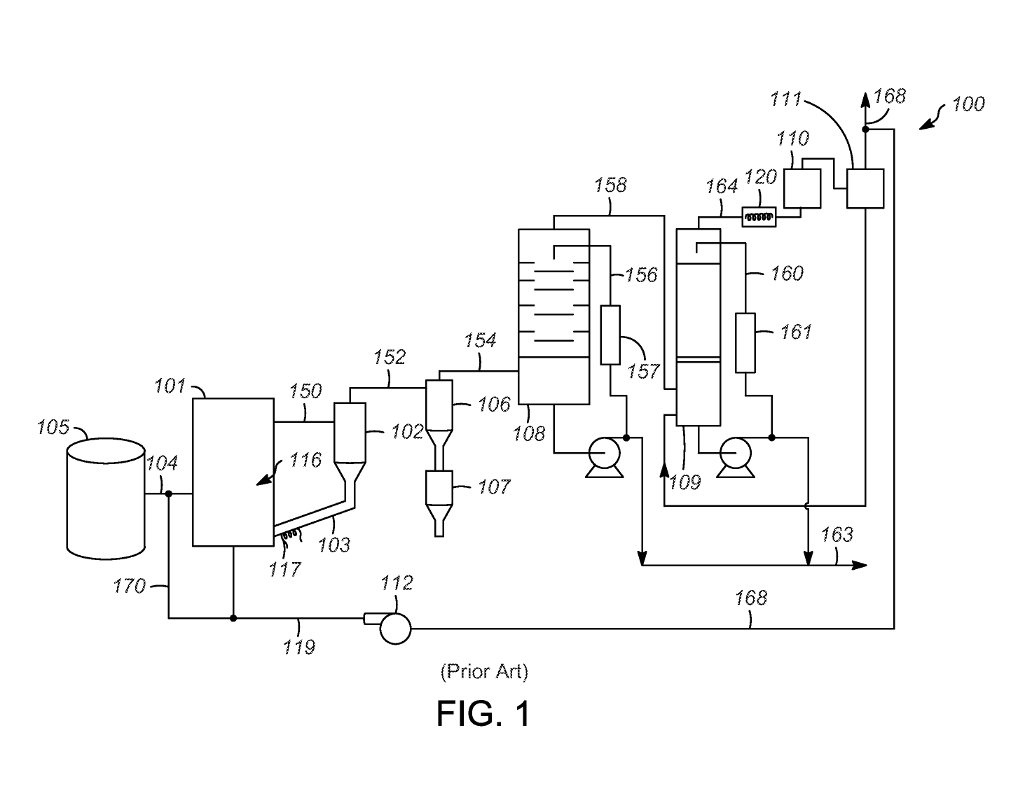

A variety of systems for the catalytic pyrolysis of biomass are known in the art. One example of such a system 100 is illustrated in FIG. 1 (other comparable systems will be readily known by those having ordinary skill in the art). The major components of the pyrolysis system 100 shown in FIG. 1 include a circulating-bed transport reactor 101, a cyclonic hot solids recirculation system 102, a cyclonic separator 106, 107, a quenching system 108, and a liquid recovery system 109. The heat required to drive the pyrolysis process is transferred to the reactor 101 by recirculated hot inorganic particulate catalytic solids, such heat being generated by, for example, the combustion of coke and biochar during regeneration of the catalyst.

Referring now to the operation of system 100, a carbonaceous feedstock is provided from a feed source 105 via feed delivery line 104 into the pyrolysis reactor 101. Upon entry into the reactor 101, the carbonaceous feedstock is contacted with the pyrolysis catalyst, which is provided in the form of a plurality of inorganic, solid particles. Any of the well-known catalysts that are used in the art of fluidized catalytic cracking, such as an active amorphous clay-type catalyst and/or a high activity, crystalline molecular sieve, may be used. Molecular sieve catalysts are preferred over amorphous catalysts because of their much-improved selectivity to desired products. Zeolites are the most commonly used molecular sieves in FCC processes. In one embodiment, the catalyst includes a large pore zeolite, such as a Y-type zeolite, an active alumina material, a binder material, including either silica or alumina and an inert filler such as kaolin. In another embodiment, the catalyst includes a medium or smaller pore zeolite catalyst exemplified by ZSM-5, ZSM-11, ZSM-12, ZSM-23, ZSM-35, ZSM-38, ZSM-48, and other similar materials. U.S. Pat. No. 3,702,886 describes ZSM-5. Other suitable medium or smaller pore zeolites include ferrierite, erionite, and ST-5, developed by Petroleos de Venezuela, S.A. It will be appreciated that the listing of catalysts provided herein is merely exemplary, and that the methods described herein may be performed on any suitable catalyst as are known in the art. The catalyst preferably disperses the medium or smaller pore zeolite on a matrix including a binder material such as silica or alumina and an inert filler material such as kaolin. The catalyst may also include some other active material such as beta zeolite.

Rapid mixing of the inorganic solid catalyst and the carbonaceous feedstock, as well as heat transfer to the carbonaceous feedstock, are carried out in the mixing section 116 of the transport reactor 101. In the mixing section 116, heat is transferred from the solid catalyst to the carbonaceous feedstock by direct contact and mixing between the components. Thorough mixing and rapid heat transfer typically occur within 10% of the desired overall transport reactor system residence time. Therefore, the mixing time is typically less than about 0.10 seconds, for example from about 0.015 to about 0.030 seconds. The heating rate of the feedstock is typically greater than 1000° C. per second for pyrolysis to occur.

After injection into the base of the reactor 101, the pyrolysis of the carbonaceous feedstock is initiated in the mixing section 116 and continues upwardly in the transport reactor 101. The products of the pyrolysis reaction include a vapor phase product (which, as noted above, can be selected based on the operating conditions of the reactor) and a solid phase product (byproduct), which includes a first amount of coke coated on the catalyst particles and the biochar. The solid inorganic catalyst particles, along with the product vapors and biochar, are carried out of the transport reactor 101 to the hot solids recirculation system 102 via line 150. In this recirculation system 102, typically provided as a cyclone, the catalyst solids are separated and removed from the vapor-phase stream, which consists of a transport gas, non-condensible product gases, and the primary condensable vapor products. The inorganic particulate solids are reheated using electric heater 117 and returned to the mixing section 116 of the reactor system 101 via a solids recirculation line 103.

Typically, there is no oxidation (combustion) occurring in the mixing and reaction zones to supply direct process heat as there is very little oxygen present in the reactor 101. Direct or indirect combustion of the biochar, externally supplied fuel, or indirect electrical resistance heating may be employed to heat and/or regenerate the recirculated catalyst solids before they are injected back into the mixing section 116. Direct combustion of the coke and biochar may occur in a separate vessel that contains an inventory of inorganic catalyst solids.

The exit 150 from the reactor system to the hot solids recirculation system is positioned to achieve a desired minimum residence time without flooding the separation/recirculation system. This position is determined by the pressure balance as determined by the parameters of pressure, flow, and physical cyclone size. The optimal height of the reactor is determined by the desired residence time, physical space constraints, and selected separation efficiency.

The non-condensed product vapors, non-condensable product and transport gases, and solid particulate fines exit from the primary hot solids recirculation system via line 152 to a secondary high-efficiency cyclone 106 where the remaining biochar, fine ash, and attributed bed materials are removed from the vapors and gases, and deposited in a solids catch-pot 107. These separated solids are then removed from the catch-pot 107 through, for example, a lock hopper system.

A hot product stream 154 (condensable and non-condensable product) from the secondary separator 106 is immediately quenched and condensed by cooled recycled liquid (either the liquid product or some other suitable liquid solvent), in a primary condenser 108, typically a direct-contact condenser column. The condensed, warm liquid stream 156 is drawn from the bottom of the primary condenser by a pump, and transported to a heat exchanger column 157 for further cooling. A first portion of the cooled liquids are then sprayed back into the top of the primary condenser column 108, and a second portion thereof exits the system as oil product 163. Residual vapor products 158 that are not condensed in the primary column are further cooled in a secondary condenser 109, typically a direct-contact condenser column. Cooled, condensed liquid product 160 is drawn from the bottom of the secondary condenser column 109 and circulated through a secondary heat exchanger column 161. The cooled, condensed liquids 160 join oil product 163. The gas stream 164 exiting from the top of the secondary condenser column 109 undergoes final cooling in a heat exchanger 120.

Persistent aerosols that escape collection are removed in a demister 110 and filter vessel 111 or other suitable scrubbing system. A portion of the product gas stream 168 is then compressed in a gas blower 112 and recirculated to the reactor 101 via lines 119, 170 to transport the feedstock, solid inorganic particulate catalyst, and products through the reactor system 100.

As noted above, the coke and biochar byproducts may be burned to reheat and regenerate the catalyst in a regeneration portion of the pyrolysis process. As shown in the prior art system in FIG. 1, direct combustion of the coke and char may occur in the solids recirculation line 103 (outside of the mixing and reaction zones) or, alternatively, in a separate vessel that contains an inventory of inorganic catalyst solids. However, for many operating conditions on many biomass feedstocks, the combustion of the coke and biochar provides more energy than required for regeneration, thus heating the catalyst to a temperature far higher than required by the biomass pyrolysis reaction, and in some cases to a temperature that can damage the catalyst. That is, the combustion occurring in line 103 or in the separate vessel may result in solid catalyst temperatures that exceed those desirable for recirculation back to the mixing section 116.

Embodiments of the present disclosure are directed to an improved catalyst regeneration process that burns the coke and the biochar in multiple stages to manage the heat release rate and lower the regenerated catalyst temperature. Multi-stage regeneration offers the possibility of combining oxygen deficient regeneration with control of the CO:CO₂ molar ratio produced during combustion. Thus, about 50% or more, such as about 65% to about 95%, for example about 80% to about 95% by weight of the biochar and coke on the catalyst immediately prior to regeneration may be removed in one or more stages of regeneration in which the molar ratio of CO:CO₂ is controlled in the manner described above. In combination with the foregoing, the last 5% or more, or 10% or more by weight of the coke originally present, up to the entire amount of coke remaining after the preceding stage or stages, can be removed in a subsequent stage of regeneration in which more oxygen is present. Multi-stage regeneration can be operated in such a manner that the total flue gas recovered from the entire, completed regeneration operation contains little or no excess oxygen, i.e. on the order of about 0.2 mole percent or less, or as low as about 0.1 mole percent or less. Thus, multi-stage regeneration is particularly beneficial in that it provides another convenient technique for restricting regeneration heat transmitted to fresh feed via regenerated catalyst and/or reducing the potential for thermal damage to the catalyst, while simultaneously affording an opportunity to reduce the carbon level on regenerated catalyst to those very low percentages (e.g. about 0.1% or less), which particularly enhance catalyst activity. Moreover, where the regeneration conditions, e.g. temperature or atmosphere, are substantially less severe in the second zone than in the first zone (e.g. by at least about 5, such as by at least about 10° C.), that part of the regeneration sequence which involves the most severe conditions is performed while there is still an appreciable amount of coke on the catalyst. Such operation may provide some protection of the catalyst from the more severe conditions.

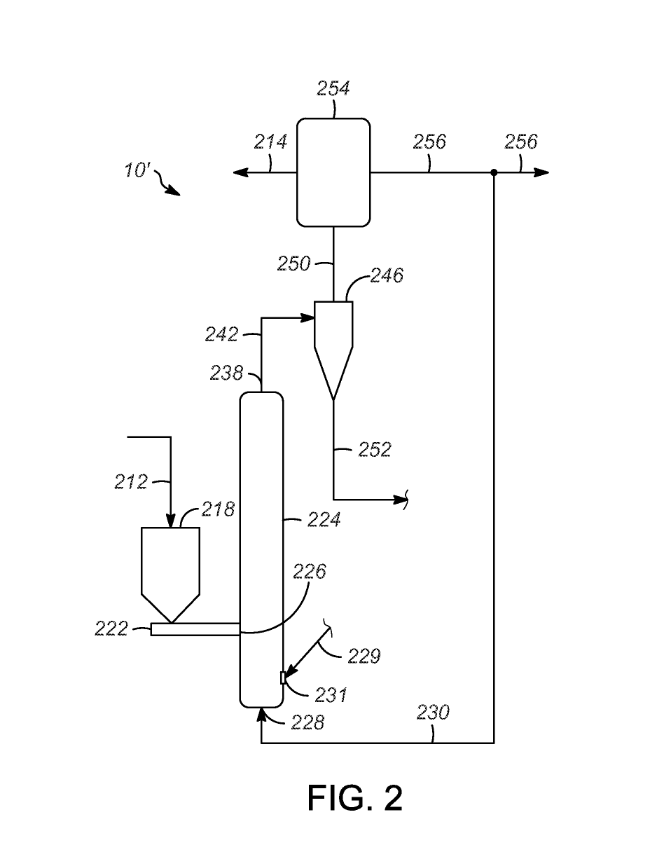

Depicted in FIGS. 2-4 is an exemplary biomass pyrolysis system 10 in accordance with one embodiment. The system 10 is illustrated in three figures for clarity, with portions 10′, 10″, and 10′″ being shown in FIGS. 2, 3, and 4, respectively. Further, certain portions of the system 10 downstream from the catalyst solids recirculation system 102 are not provided for ease of illustration (for example, the quenching and liquid recovery systems); however, those having ordinary skill in the art will be able to conceive the remainder of the system 10, for example based on the system 100 fully described in connection with FIG. 1.

In accordance with the various embodiments herein, FIG. 2 illustrates portion 10′ of an apparatus for thermally converting biomass, entering via line 212, to produce pyrolysis oil, exiting via line 214. The apparatus includes a hopper or feed bin 218 for receiving the biomass from line 212. The hopper 218 is in communication with a reactor feed chamber 222 formed by, for example, an auger, a screw feed device, a conveyor, or other batch feed device. The reactor feed chamber 222 is further selectively connected to a thermal conversion or pyrolysis reactor 224 configured to thermally convert or pyrolyze the biomass. The thermal conversion reactor 224 includes a biomass inlet 226 for receiving the biomass from the reactor feed chamber 222. Further, the thermal conversion reactor 224 includes a carrier gas inlet 228 for receiving a carrier gas, supplied via line 230 (as will be discussed in greater detail below). The thermal conversion reactor 224 may also include a solid heat transfer medium inlet 231 to receive hot heat transfer medium, such as sand, catalyst, or other inert particulate, via line 229. Alternatively, the heat transfer medium may be mixed with and carried by the carrier gas from line 230 through the carrier gas inlet 228.

As the biomass is heated by the heat transfer medium to the thermal conversion or pyrolysis temperature, typically about 500° C., the thermal conversion or pyrolysis reaction occurs and pyrolysis vapor and char are formed in the thermal conversion reactor 224. The pyrolysis vapor and char, along with the heat transfer medium, are carried out of an outlet 238 in the thermal conversion reactor 224 and through a line 242 to a separator 246, such as, for example, a cyclone. The separator 246 separates the pyrolysis vapor, which exits via line 250, from the char and heat transfer medium, which exits via line 252. As shown, the pyrolysis vapor line 250 is directed to a condenser 254 which condenses the pyrolysis vapor to form the pyrolysis oil, which exits via line 214. Uncondensed gas thereafter exits the condenser 254 via line 256. A first portion of uncondensed gas in line 256 is recycled as the carrier gas 230 (described above). A second portion of uncondensed gas in line 256 is withdrawn as a gas product.

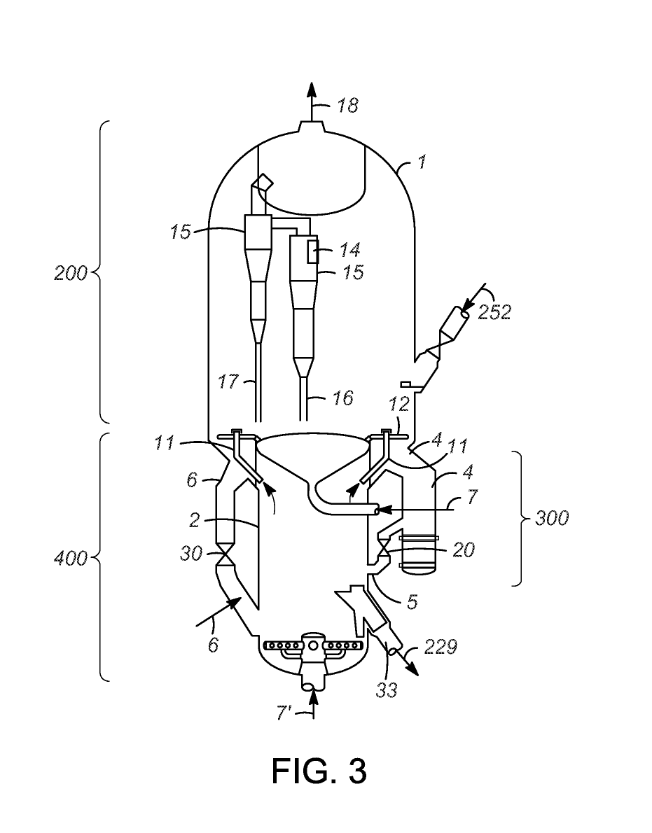

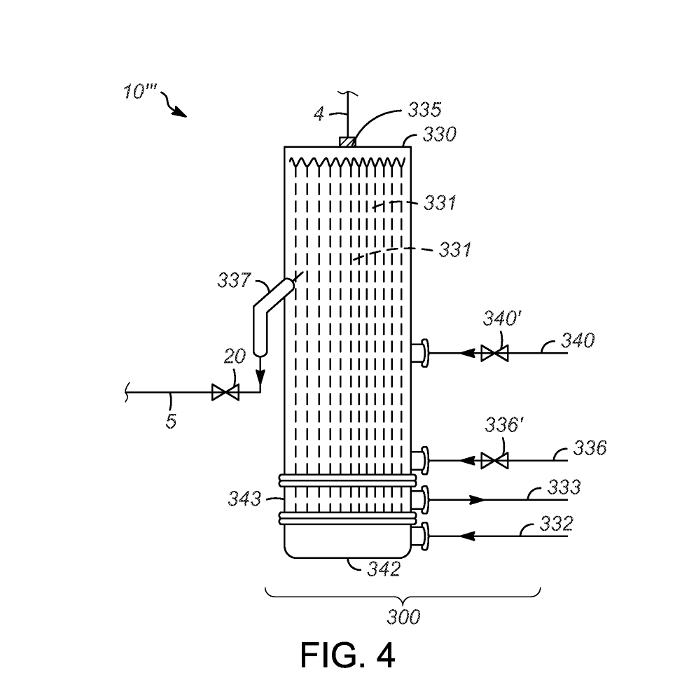

The char and heat transfer medium are fed to a regeneration system via line 252, as is further detailed in portion 10″ of the apparatus as shown in FIG. 3. FIG. 3 generally depicts first regeneration stage 200, a cooling system 300 (which is illustrated in greater detail in FIG. 4), and a second regeneration stage 400. In FIG. 3, regeneration gas, which may be air or another oxygen containing gas, enters in line 7, is distributed to the first regeneration stage 200 via a plurality of air distribution arms 12 configured in a hub-and-spoke type configuration, and mixes with coke-contaminated heat transfer medium/catalyst (which as noted above is transported from portion 10′ via line 252), and also with hot, oxygen-depleted flue gas from second regeneration stage 400 (as will be described in greater detail below) entering via conduit 11, which is provided as a series of combustion gas vents that allow the combustion gas from the combustion zone 2 of the second regeneration stage 400 to vent into the gas space of combustion zone 1 of the first regeneration stage 200. The resultant mixture of coke contaminated catalyst and regeneration gas are distributed into the interior of combustion zone 1 of first regeneration stage 200. Coke contaminated catalyst commonly contains from about 5 to possibly greater than about 25 wt. % carbon, as coke. Coke predominantly includes carbon; however, it can contain from about 5 to about 15 wt. % hydrogen, as well as sulfur and other materials. The regeneration gas and entrained catalyst flows upward from the lower part of combustion zone 1 to the upper part thereof in dilute phase. The term “dilute phase”, as used herein shall mean a catalyst/gas mixture of less than about 25 lbs. per cubic foot, and “dense phase” shall mean such mixture equal to or more than 25 lbs. per cubic foot. As the catalyst/gas mixture ascends within combustion zone 1 the heat of combustion of coke is liberated and absorbed by the now reduced-carbon catalyst/heat transfer medium, in other words by the partially regenerated catalyst/heat transfer medium. The gaseous products of coke oxidation and excess regeneration gas, or flue gas, and the very small uncollected portion of hot regenerated catalyst flow up through combustion zone 1 and enters separation means 15 through inlet 14.

These separation means may be cyclone separators, as schematically shown in FIG. 3, or any other effective means for the separation of particulated catalyst from a gas stream. Catalyst separated from the flue gas falls to the bottom of combustion zone 1 through conduits 16 and 17. The flue gas exits combustion zone 1 via conduit 18, through which it may safely proceed to associated energy recovery systems.

A first portion of catalyst separated by separation means 15 and conduits 16 and 17 is passed in dense phase, via first catalyst recycle conduit 4, downwardly through a cooling system 300, which includes a heat exchanger, which is described in greater detail below with regard to FIG. 4. First catalyst recycle conduit 4 connects to the top of cooling system 300. It will be appreciated that depending on the size of the apparatus 10, one, two, or more individual cooling systems may be required. Control valve 20 is placed in connection with cooling system 300 and catalyst discharge conduit 5 to control the catalyst flow. There may further be a catalyst flow control means that is not shown regulating catalyst flow to and from cooling system 300, such as means to control the amount of catalyst in the cooling system 300 by controlling the flow of catalyst through a catalyst inlet valve upstream of the cooling system responsive to the pressure differential across the catalyst head in the cooling system.

A second portion of the hot, partially regenerated catalyst is also sent to second regeneration stage 400 via line 6, which bypasses the cooling system 300. As noted above, it is desirable to control the temperature of the solid catalyst particles within a prescribed temperature range during the catalyst regeneration process. That is, there is a maximum temperature limit set by the catalyst thermal stability and there is a minimum temperature requirement determined by the need to burn the coke within the residence time available in the regenerator. Thus, after the first regeneration stage 200, the ratio of the first portion of the partially regenerated catalyst and the remaining (non-combusted) biochar that is cooled in the heat exchanger cooling system 300 that is mixed with the second portion of the hot, partially regenerated catalyst in second regeneration stage 400 is controlled to maintain the desired fully-regenerated catalyst temperature.

With reference now to FIG. 4, the cooling system 300 includes a shell-and-tube heat exchanger 330 having a vertical orientation with the catalyst provided to the shell side and the heat exchange medium, supplied and recovered by lines 332 and 333, passing through a tube bundle 331. Other cooling system configurations, known in the art, may alternatively be employed as cooling system 300; as such, the configuration set forth in FIG. 4 is to be understood as exemplary and non-limiting. An exemplary heat exchange medium is water, which changes only partially from liquid to gas phase (steam) when passing through the tubes. The heat exchanger 330 is operated such that the exchange medium is circulated through the tubes at a constant rate.

The tube bundle in the heat exchanger, in one embodiment, is provided in the “bayonet” type wherein one end of the bundle is unattached, thereby minimizing problems due to the expansion and contraction of the tubes when exposed to and removed from the high regenerated catalyst temperatures. Heat transfer proceeds from the catalyst, through the tube walls, and into the heat transfer medium. The upper portion of heat exchanger 330 is sealed in communication with first catalyst recycle conduit 4 via inlet 335, connected with combustion zone 1 of first stage regenerator 200, which serves as a withdrawal point for removing catalyst and biochar from the first regenerator 200 as noted above. Cooled catalyst is withdrawn from a mid-portion of exchanger 330 and sent downstream for further processing, as will be described in greater detail below. For example, catalyst and biochar is withdrawn from the mid-portion through an outlet 337 and delivered to the catalyst discharge conduit 5 having the flow control valve 20. As noted above, valve 20 may be provided to regulate catalyst and biochar flow out of conduit 5, in optional cooperation with a controlling means.

The portion of the heat exchanger bounded by inlet 335 and outlet 337 is referred to as the flow-through portion and operates with a net flow of catalyst through this portion. The portion of the heat exchanger below outlet 337 is termed the backmix portion. The lower or backmix portion of the exchanger normally has at least 10% of the heat removal capacity of the exchanger, for example it has a heat removal equal to at least 25% of the total heat removal capacity of the exchanger.

Fluidizing gas, preferably air, is passed into a lower portion of the shell side of heat exchanger 330 via lines 336 and 340, thereby maintaining a dense phase fluidized particle bed in the shell side. Lines 336 and 340 have valves 336′ and 340′, respectively, positioned thereacross to regulate the flow of fluidizing gas. The fluidizing gas effects turbulent backmixing in the backmix portion of the heat exchanger and allows catalyst particle transport through the flow-through portion of the exchanger. As fluidizing gas entering through line 336 flows upward, it effects the necessary backmixing for heat transfer in the backmix portion of the heat exchanger and as it passes into the flow-through portion of the heat exchanger, provides fluidization for catalyst particle transport. Heat removal, or in other words heat exchanger duty, can also be controlled by adjusting the flow rate of gas addition through line 336. A higher flow rate will increase heat transfer and raise the exchanger duty.

Although FIG. 4 illustrates the addition of the fluidizing gas to the bottom of the heat exchanger, fluidizing gas may be added at multiple locations in other embodiments. Adding fluidizing gas at various locations allows for independent control of exchanger duty in the backmix portion.

The tube bundle shown in the exchanger is of the aforementioned bayonet type in which all of the tubes are attached to a single tube sheet located at the bottom of the heat exchanger. A typical configuration of tubes in the bayonet-type bundle would be one-inch tubes each ascending from an inlet manifold 342 in the heat of the exchanger up into the shell through a three-inch tube sealed at its top. Each one-inch tube empties into the top of the three-inch tube in which it is contained. A liquid, such as water, is passed up into the one-inch tubes, proceeds therefrom into the three-inch tubes, and absorbs heat from the hot catalyst through the wall of the three-inch tubes as it passed downward through the annular space of the three-inch tubes and exits the heat exchanger, at least partially vaporized, from an outlet manifold 343.

With reference back to FIG. 3, after cooling in the cooling system 300, the cooled solid catalyst and remaining biochar are routed to second regeneration stage 400 via discharge conduit 5, where additional air is provided via line 7′, further regenerating the catalyst. The second regeneration stage 400 may operate in a manner analogous to that described above with regard to first regeneration stage 200, but under a second oxidizing condition with excess oxygen provided to substantially complete the combustion of the carbon-containing byproducts (i.e., the coke and the biochar). Regeneration of the catalyst may be completed by the second stage 400 or optionally, additional stages (with inter-stage cooling) may be incorporated. In the final stage, for example regeneration stage 400, excess air is provided via line 7′ to complete the regeneration of the catalyst and the temperature is controlled by the quantity of excess air added together with the amount of heat removed from the catalyst bed using a catalyst cooler. The CO-rich flue gas from each stage is combined and sent to a boiler where carbon monoxide (CO) is combusted to carbon dioxide (CO₂) and steam is recovered.

After the final regeneration stage, the regenerated catalyst is returned/recycled to the reactor 224 via discharge conduit 33 and line 229, which is also shown in FIG. 2 (in embodiments where two regeneration stages are provided). The regenerated solid catalyst includes a third amount of coke coated thereon that is less than the second amount, for example less than about 5% carbon (coke), such as less than about 1% carbon. The regenerated catalyst is thus returned to reactor 224 for contact with additional fresh feedstock from feed supply line 212. Whatever heat is introduced into the recycled catalyst in the regeneration stages (and not removed via inter-stage cooling) is available for heat transfer with the fresh feedstock in the reactor 224, thus continuing the pyrolysis of additional biomass feedstock with the regenerated catalyst.

Accordingly, an improved biomass pyrolysis reactor system is provided that includes a regenerator that is able to combust the coke on the catalyst and the biochar without overheating the catalyst. The regenerator is provided in multiple stages, with inter-stage cooling, to maintain the temperature of the catalyst below a desired maximum. As such, the presently disclosed systems and methods substantially lessen the likelihood of damage to the pyrolysis catalyst during the regeneration thereof.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the processes without departing from the scope defined by the claims, which includes known equivalents and foreseeable equivalents at the time of this disclosure.

What is claimed is:

1. A method for the catalytic pyrolysis of a carbonaceous material comprising:
contacting the carbonaceous material with a plurality of catalyst particles to produce a gas phase product and a solid phase product;
separating the gas phase product from the solid phase product and the plurality of catalyst particles;
partially regenerating the plurality of catalyst particles by exposing the solid phase product and the catalyst particles to a first oxidizing condition to produce an oxidized solid phase and a partially-regenerated catalyst;
cooling the partially-regenerated catalyst and a non-oxidized portion of the solid phase product; and
further regenerating the partially-regenerated catalyst by exposing the non-oxidized portion of the solid phase product and the partially-regenerated catalyst to a second oxidizing condition to produce a regenerated catalyst.

2. The method of claim 1, wherein contacting the carbonaceous material with the plurality of catalyst particles comprises contacting a biomass feedstock with the plurality of catalyst particles.

3. The method of claim 1, wherein contacting the carbonaceous material with the plurality of catalyst particles comprises contacting the carbonaceous material with a solid, inorganic zeolite-based pyrolysis catalyst.

4. The method of claim 1, wherein separating the gas phase product from the solid phase product and the plurality of catalyst particles comprises cyclonically separating the gas phase product from the solid phase product and the plurality of catalyst particles.

5. The method of claim 1, wherein contacting the carbonaceous material with the plurality of catalyst particles to produce the gas phase product and the solid phase product comprises contacting the carbonaceous material with the plurality of catalyst particles to produce the gas phase product, a solid phase biochar, and a solid phase coke material coated on the plurality of catalyst particles.

6. The method of claim 5, wherein partially regenerating the plurality of catalyst particles comprises combusting the solid phase biochar and the solid phase coke material under oxygen-limiting conditions.

7. The method of claim 6, wherein further regenerating the partially-regenerated catalyst comprises combusting the non-oxidized portion of the solid phase product and any remaining coke material on the partially-regenerated catalyst in an excess of oxygen.

8. The method of claim 1, wherein cooling the partially-regenerated catalyst and the non-oxidized portion of the solid phase product comprises exchanging heat between the partially-regenerated catalyst and the non-oxidized portion of the solid phase product and a heat transfer agent.

9. The method of claim 1, further comprising condensing the gas phase product.

10. The method of claim 1, further comprising recycling the regenerated catalyst and contacting the regenerated catalyst with further carbonaceous material.

11. A system for the catalytic pyrolysis of a carbonaceous material comprising:
a pyrolysis reactor configured to contact the carbonaceous material with a pyrolysis catalyst to produce a gas phase product and a solid phase product;
a separation system configured to separate the gas phase product from the solid phase product;
a first regeneration system configured to oxidize the solid phase product and produce an oxidized solid phase and a partially-regenerated catalyst;
a cooling system configured to cool the partially-regenerated catalyst and any non-oxidized solid phase; and
a second regeneration system configured to oxidize the non-oxidized solid phase and produce a regenerated catalyst.

12. The system of claim 11, wherein the pyrolysis reactor comprises a circulating bed transport reactor.

13. The system of claim 11, wherein the separation system comprises a cyclone separator.

14. The system of claim 11, wherein the cooling system comprises a shell-and-tube heat exchanger.

15. The system of claim 11, wherein the carbonaceous material comprises a biomass feedstock.

16. The system of claim 11, wherein the solid phase product comprises biochar and a first amount of coke material coated on the pyrolysis catalyst.

17. The system of claim 16, wherein the partially-regenerated catalyst comprises the pyrolysis catalyst with a second amount of coke material coated thereon that is less than the first amount.

18. The system of claim 17, wherein the regenerated catalyst comprises the pyrolysis catalyst with a third amount of coke material coated thereon that is less than the second amount.

19. The system of claim 11, further comprising a condenser configured to condense the gas phase product.
